(19) United States
(12) Patent Application Publication
(10) Pub. No.: US 2026/0005546 A1
(43) Pub. Date: Jan. 1, 2026

(54) DISTRIBUTED SYSTEM FOR ENERGY INTERCONNECTION

(71) Applicant: CZAR Power Inc., Dover, DE (US)

(72) Inventors: Xuntuo Wang, Cambridge, MA (US); Anthony J. Frisone, Akron, OH (US)

(73) Assignee: CZAR Power Inc., Dover, DE (US)

(21) Appl. No.: 19/250,444

(22) Filed: Jun. 26, 2025

Related U.S. Application Data
(60) Provisional application No. 63/665,116, filed on Jun. 27, 2024.

(51) Int. Cl. H02J 13/00; H02J 3/00; H02J 3/32; H02J 3/38

(52) U.S. Cl. CPC H02J 13/00036; H02J 3/003; H02J 3/322; H02J 3/381; H02J 2203/20; H02J 2300/24; H02J 2310/16

(57) ABSTRACT

Described herein are energy interconnection and distribution techniques that may be deployed in a distributed system interconnecting a plurality of energy interconnection subsystems at various locations. Some embodiments of the present disclosure improve efficiency, proactivity, and flexibility of energy interconnections throughout the distributed system by leveraging energy data acquired using sensors in each energy interconnection subsystem and aggregated into a real-time stream, provided to each subsystem, that includes aggregated energy data representative of the distributed system as a whole. In some embodiments, an energy interconnection subsystem may further serve as a data acquisition subsystem, such as by acquiring energy data for processing and/or distribution by the distributed system.

### RELATED APPLICATIONS

This application claims the benefit of U.S. Provisional Patent Application Ser. No. 63/665,116, filed Jun. 27, 2024, entitled “Distributed System for Energy Interconnection,” which is incorporated herein by reference in its entirety.

### FIELD

The present disclosure relates generally to systems and methods for controlling energy interconnection between energy source connection interfaces and energy draw connection interfaces, including in a distributed system of interconnection subsystems in which such interconnections may occur.

### BACKGROUND

Energy is supplied to various locations for local use, which may include powering locally situated electronics (e.g., HVAC systems), charging electric vehicles, and/or storing power in energy storage systems (ESS). Energy may also be generated locally, such as using wind or solar power, either for local use or to supply to the power grid for use elsewhere.

### SUMMARY

The present disclosure relates generally to energy interconnection and distribution techniques that may be employed in a distributed system in communication with a plurality of energy interconnection subsystems at various locations. Some embodiments of the present disclosure improve efficiency, proactivity, and flexibility of energy interconnections throughout the distributed system, as compared to previous interconnection implementations, by leveraging energy data acquired using sensors in each energy interconnection subsystem and aggregated into a real-time stream, provided to each subsystem, that includes aggregated energy data representative of the distributed system as a whole. In some embodiments, an energy interconnection subsystem may further serve as a data acquisition subsystem, such as by acquiring energy data for processing and/or distribution by the distributed system. For example, sensors of respective energy interconnection subsystems may be configured, in the aggregate, as a distributed sensing apparatus leveraging control, communication, and/or aggregation processing circuitry that may be distributed among the energy interconnection subsystems and/or a data center.

According to one aspect of the present disclosure, a distributed system is provided. In one set of embodiments, the distributed system comprises a data center and a plurality of energy interconnection subsystems. In one set of embodiments, each energy interconnection subsystem comprises a plurality of energy connection interfaces comprising an energy source connection interface and an energy draw connection interface, a bus coupled to and between each of the plurality of energy connection interfaces and comprising a sensor, a plurality of switches each coupled to and between the bus and a respective energy connection interface of the plurality of energy connection interfaces, and processing circuitry coupled to the bus and to each of the plurality of switches and in communication with the data center over a communication network. In one set of embodiments, the processing circuitry is configured to receive energy data from the bus based on sensor data generated by the sensor at least during transmission of energy between the energy source connection interface and the energy draw connection interface and transmit the energy data to the data center over the communication network.

In the same or another set of embodiments, each of the plurality of energy interconnection subsystems is located at a different geographical location.

In the same or another set of embodiments, the processing circuitry comprises digital signal processing circuitry configured to receive and transmit the energy data and further to control operation of the plurality of switches.

In the same or another set of embodiments, the plurality of switches comprises a plurality of digitally controlled power relays.

In the same or another set of embodiments, the data center comprises processing circuitry configured to receive and aggregate the energy data from each of the plurality of energy interconnection subsystems into aggregated energy data and transmit the aggregated energy data to each of the plurality of energy interconnection subsystems.

In the same or another set of embodiments, the processing circuitry of a first energy interconnection subsystem of the plurality of energy interconnection subsystems is configured to receive the aggregated energy data and control the plurality of switches of the first energy interconnection subsystem based on the aggregated energy data.

In the same or another set of embodiments, the processing circuitry of the first energy interconnection subsystem is configured to input the aggregated energy data to a trained model and control the plurality of switches based on a resulting output of the trained model.

According to another aspect of the present disclosure, a distributed system is provided. In one set of embodiments, the distributed system comprises a data center and a plurality of energy interconnection subsystems. In one set of embodiments, each energy interconnection subsystem comprises a plurality of energy connection interfaces comprising an energy source connection interface and an energy draw connection interface, a plurality of switches each coupled to and between the plurality of energy connection interfaces, and processing circuitry coupled to each of the plurality of switches and in communication with the data center over a communication network. In one set of embodiments, the processing circuitry is configured to receive aggregated energy data from the data center over the communication network, the aggregated energy data including energy data generated by the plurality of energy interconnection subsystems and transmitted, over the communication network, to the data center and, based on the aggregated energy data, operate the plurality of switches to connect and/or disconnect the energy source connection interface to and/or from the energy draw connection interface.

In the same or another set of embodiments, the processing circuitry is configured to execute a trained model, input the aggregated energy data to the trained model, and operate the plurality of switches based on a resulting output of the trained model.

In the same or another set of embodiments, the trained model comprises a trained statistical classifier, and the resulting output comprises an indication of a predicted need for additional energy and/or an indication of a predicted surplus of additional energy.

In the same or another set of embodiments, the aggregated energy data indicates greater than a threshold amount of aggregate energy usage, the energy source connection interface comprises a power grid connection interface, and the processing circuitry is configured to operate the plurality of switches to disconnect the power grid connection interface from the energy draw connection interface.

In the same or another set of embodiments, the aggregated energy data indicates less than a threshold amount of aggregate energy usage, the energy source connection interface comprises a power grid connection interface, and the processing circuitry is configured to operate the plurality of switches to connect the power grid connection interface to the energy draw connection interface.

In the same or another set of embodiments, the energy draw connection interface comprises a vehicle charging connection interface and/or an energy storage system connection interface.

In the same or another set of embodiments, the aggregated energy data indicates greater than a threshold amount of aggregate energy usage, the energy draw connection interface comprises a power grid connection interface, and the processing circuitry is configured to operate the plurality of switches to connect the energy source connection interface to the power grid connection interface.

In the same or another set of embodiments, the energy source connection interface comprises a solar power connection interface and/or an energy storage system connection interface.

In the same or another set of embodiments, each of the plurality of energy interconnection subsystems further comprises a bus coupled to and between each of the plurality of energy connection interfaces and comprising a sensor, with the plurality of switches coupled to and between the bus and a respective energy connection interface of the plurality of energy connection interfaces.

In the same or another set of embodiments, the energy data is generated by the sensors of the plurality of energy interconnection subsystems and transmitted by the processing circuitry of the plurality of energy interconnection subsystems, over the communication network, to the data center.

In the same or another set of embodiments, each of the plurality of energy interconnection subsystems is located at a different geographical location.

In the same or another set of embodiments, the data center comprises processing circuitry configured to receive the energy data from each of the plurality of energy interconnection subsystems over the communication network, aggregate the energy data into the aggregated energy data, and transmit the aggregated energy data to each of the plurality of energy interconnection subsystems over the communication network.

According to another aspect of the present disclosure, a distributed system is provided. In one set of embodiments, the distributed system comprises a plurality of energy interconnection subsystems and a data center. In one set of embodiments, each energy interconnection subsystem comprises a plurality of energy connection interfaces comprising an energy source connection interface and an energy draw connection interface, a bus coupled to and between each of the plurality of energy connection interfaces and comprising a sensor, a plurality of switches each coupled to and between the bus and a respective energy connection interface of the plurality of energy connection interfaces, and processing circuitry coupled to the bus and to each of the plurality of switches. In one set of embodiments, the data center comprises processing circuitry in communication with the processing circuitry of each of the plurality of energy interconnection subsystems over a communication network. In one set of embodiments, the processing circuitry of the data center is configured to obtain from the processing circuitry of the plurality of energy interconnection subsystems, over the communication network, energy data from the buses based on sensor data generated by the sensors at least during transmission of energy between the energy source connection interfaces and the energy draw connection interfaces, respectively, aggregate the energy data into aggregated energy data, and, based on the aggregated energy data, associate the energy source connection interface of a first energy interconnection subsystem of the plurality of energy interconnection subsystems with the energy draw connection interface of a second energy interconnection subsystem of the plurality of energy interconnection subsystems.

In the same or another set of embodiments, the energy source connection interface of the first energy interconnection subsystem and the energy draw connection interface of the second energy interconnection subsystem each comprises a power grid connection interface.

In the same or another set of embodiments, each of the plurality of energy interconnection subsystems is located at a different geographical location.

In the same or another set of embodiments, the processing circuitry of the data center is configured to associate the energy source connection interface of the first energy interconnection subsystem with the energy draw connection interface of the second energy interconnection subsystem at least in part by transmitting an indication to the first energy interconnection subsystem, over the communication network, for the processing circuitry of the first energy interconnection subsystem to operate the plurality of switches to connect the bus to the energy source connection interface and transmitting an indication to the second energy interconnection subsystem, over the communication network, for the second energy interconnection subsystem to operate the plurality of switches to connect the bus to the energy draw connection interface.

In the same or another set of embodiments, the processing circuitry of the data center is configured to associate the energy source connection interface of the first energy interconnection subsystem with the energy draw connection interface of the second energy interconnection subsystem responsive to determining that a condition is satisfied based on the aggregated energy data, the energy data from the first energy interconnection subsystem, and the energy data from the second energy interconnection subsystem.

In the same or another set of embodiments, the aggregated energy data indicates an aggregate availability and usage of energy, the energy data from the first energy interconnection subsystem indicates a prediction of energy available from the energy source connection interface, and the energy data from the second energy interconnection subsystem indicates a prediction of energy needed at the energy draw connection interface.

In the same or another set of embodiments, the condition comprises a compatibility between the prediction of energy available from the energy source connection interface of the first energy interconnection subsystem and the prediction of energy needed at the energy draw connection interface of the second energy interconnection subsystem.

According to another aspect of the present disclosure, a method of operating an energy interconnection subsystem is provided. In one set of embodiments, the method comprises receiving, by processing circuitry of an energy interconnection subsystem, aggregated energy data over a communication network, the aggregated energy data being representative of energy data obtained from a plurality of energy interconnection subsystems connected to a data center over the communication network, operating in a first mode, comprising inputting the aggregated energy data to a first model, and, based on an output from the first model, controlling switches interconnecting a plurality of energy interconnection interfaces, and operating in a second mode, comprising inputting the aggregated energy data to a second model, and, based on an output from the second model, controlling the switches.

Other advantages and novel features of the present disclosure will become apparent from the following detailed description of various non-limiting embodiments of the present disclosure.

### BRIEF DESCRIPTION OF THE DRAWINGS

Non-limiting embodiments of the present disclosure will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the present disclosure shown where illustration is not necessary to allow those of ordinary skill in the art to understand the present disclosure. In the figures:

FIG. 1 is a block diagram of an example distributed system, according to some embodiments;

FIG. 2 is a block diagram of an example energy interconnection subsystem of the system of FIG. 1, according to some embodiments;

FIG. 3 is a block diagram of an example controller coupled to switches of a device of the energy interconnection subsystem of FIG. 2, according to some embodiments;

FIG. 4 is a flow diagram of an example method of controlling energy interconnection in an energy interconnection subsystem using multiple modes of operation, according to some embodiments; and

FIG. 5 is a block diagram of example processing circuitry that may be configured to perform at least some processing operations described herein for the system of FIG. 1, in accordance with some embodiments.

### DETAILED DESCRIPTION

The present disclosure provides energy interconnection and distribution techniques that may be deployed in a distributed system interconnecting a plurality of energy interconnection subsystems at various locations. Some embodiments of the present disclosure improve efficiency, proactivity, and flexibility of energy interconnections throughout the distributed system, as compared to previous interconnection implementations, by leveraging energy data acquired using sensors in each energy interconnection subsystem and aggregated into a real-time stream, provided to each subsystem, that includes aggregated energy data representative of the distributed system as a whole. In some embodiments, an energy interconnection subsystem may further serve as a data acquisition subsystem, such as by acquiring energy data for processing and/or distribution by the distributed system. For example, sensors of respective energy interconnection subsystems may be configured, in the aggregate, as a distributed sensing apparatus leveraging control, communication, and/or aggregation processing circuitry that may be distributed among the energy interconnection subsystems and/or a data center.

According to an aspect of the present disclosure, a distributed system may include a data center and a plurality of energy interconnection subsystems. For example, the data center may be located in a geographical region and the energy interconnection subsystems located in different geographical locations within the geographical region, such as at locations where energy is interconnected among energy sourcing devices (e.g., solar panel systems) and/or energy drawing devices (e.g., HVAC systems). For instance, within the distributed system, the data center may be in communication with each of the energy interconnection subsystems, such as over a network.

In some embodiments, each energy interconnection subsystem may include a plurality of energy connection interfaces, which in turn include an energy source connection interface and an energy draw connection interface. For example, energy connection interfaces may include power connections that permit sourcing power from and/or drawing power, such as an energy source connection interface configured as a solar power connection interface and/or an energy draw connection interface configured as an HVAC system power connection interface. It should be appreciated that an energy source connection interface may be further configured as an energy draw connection interface and/or vice versa, for example in the case of a power grid connection interface and/or an ESS connection interface, where energy may be sourced at some times and/or in some system states and drawn at other times and/or in other system states (e.g., as in battery systems or electric vehicles that can operate in source and draw states).

In some embodiments, each energy interconnection subsystem may further include a bus coupled to and between each of the plurality of energy connection interfaces and including a sensor. For example, the bus may be configured to provide an electrical path for power to flow between the energy interconnection interface, and the sensor may be configured to detect characteristics of energy flowing in the electrical path, such as voltage and/or current.

In some embodiments, each energy interconnection subsystem may further include a plurality of switches, each coupled to and between the bus and a respective energy connection interface. For example, the switches may be controllable to interconnect ones of the energy connection interfaces (e.g., an energy source connection interface and an energy draw connection interface) via the bus to transfer power therebetween.

In some embodiments, each energy interconnection subsystem may further include processing circuitry coupled to the bus and to each of the switches and in communication with the data center over a communication network. For example, the processing circuitry may be configured to execute a network interface for communication with the data center, such as over the Internet and/or over a private network, whether wired and/or wireless.

In some embodiments, the processing circuitry of an energy interconnection subsystem may be configured to receive energy data from the bus based on sensor data generated by the sensor at least during transmission of energy between the energy source connection interface and the energy draw connection interface. For example, the energy data may indicate a voltage, current, and/or power level of the transmission of energy, and/or may indicate which energy connection interfaces were involved in the transmission (e.g., from a power grid connection interface to an ESS connection interface). For instance, sensor data may indicate ten minutes of 1 kilowatt (kW) transmission from a power grid connection interface to an HVAC system connection interface (e.g., to operate air conditioning), such as where a sensor detects 110 V, 9.1 A alternating current (AC) transmission for a duration of ten minutes while switches that connect the power grid connection interface to the HVAC system connection interface are closed.

In some embodiments, the processing circuitry may be further configured to transmit the energy data to the data center over the communication network. For example, the data center may be configured to receive such energy data from each of the energy interconnection subsystems for processing (e.g., aggregation) thereof, which may be used to form an aggregated energy data stream for providing to the energy interconnection subsystems. In some embodiments, the data center may include processing circuitry configured to receive and aggregate the energy data from each of the plurality of energy interconnection subsystems into aggregated energy data and transmit the aggregated energy data to each of the plurality of energy interconnection subsystems. For example, each energy interconnection subsystem (e.g., processing circuitry thereof) may be configured to control switches based on the aggregated energy data, which may take into account energy availability and/or usage data based on energy interconnection activity at other energy interconnection subsystems.

In some embodiments, the processing circuitry of a first energy interconnection subsystem of the energy interconnection subsystems may be configured to receive the aggregated energy data (e.g., from the data center) and control the switches of the first energy interconnection subsystem based on the aggregated energy data. For example, the first energy interconnection subsystem may be configured to draw energy from an ESS connection interface to a power grid connection interface based on the aggregated energy data indicating a need for additional energy, and/or vice versa based on the aggregated energy data indicating a surplus of available energy. In some embodiments, the processing circuitry of the first energy interconnection subsystem may be configured to input the aggregated energy data to a trained model and control the plurality of switches based on a resulting output of the trained model. For example, a resulting output of a trained model (e.g., classifier) may indicate a state of the switches, which may be informed by training of the model (e.g., to produce efficient interconnection of connection interfaces using real-time and/or stored energy data). For instance, a trained model may be trained on real-time data, such as on the order of seconds, facilitating low-latency energy interconnection determinations made locally at a subsystem.

In some embodiments, a trained model may be trained with weighting for accommodating high power draw from an energy draw connection interface, such that an output of the trained model predicts efficient but sufficient energy source connection interfaces from which to draw the power. For example, depending on whether current power grid consumption is high or low, less or more power may be drawn from the power grid connection interface, respectively, such as with other power potentially being selectively drawn from another energy source connection interface (e.g., ESS). In some embodiments, a trained model may be trained with weighting for sourcing low power from a power grid connection interface and/or drawing power to a power grid connection interface (e.g., when available power via the power grid connection interfaces of the distributed system is low) such that an output of the trained model predicts efficient interconnections for sourcing and drawing power during times of high consumption. For example, when power consumption is high, energy may be supplied to the power grid from ESS and/or solar energy as an alternative or in addition to drawing that energy locally at the subsystem. In some embodiments, a trained model may be trained with weighting for sourcing (e.g., relatively high) power from a power grid connection interface (e.g., when available power via the power grid connection interfaces of the distributed system is high) such that an output of the trained model predicts efficient interconnections for sourcing and drawing power during times of low consumption. For example, when power consumption is low, energy may be drawn from the power grid to ESS and/or in more substantial amounts for drawing locally (e.g., to a machine learning compute center) as compared to drawing from ESS. In some embodiments, cost of energy from the power grid may be included as an alternative or additional weighting (e.g., similarly to how high and/or low power consumption may be considered).

In some embodiments, the processing circuitry of an energy interconnection subsystem may include digital signal processing circuitry configured to receive and transmit the energy data and further to control operation of the switches. For example, digital signal processing circuitry may be configured to provide low latency reception, transmission, and/or switch control. In some embodiments, the plurality of switches may include digitally controlled power relays. For example, digitally controlled power relays may be configured to provide low latency switching.

According to an aspect of the present disclosure, a distributed system may include a data center and a plurality of energy interconnection subsystems, each of the energy interconnection subsystems including a plurality of energy connection interfaces that include an energy source connection interface and an energy draw connection interface, a plurality of switches each coupled to and between the plurality of energy connection interfaces and processing circuitry coupled to each of the plurality of switches and in communication with the data center over a communication network. For example, the energy interconnection subsystems may be configured as described above.

In some embodiments, the processing circuitry of each energy interconnection subsystem may be configured to receive aggregated energy data from the data center over the communication network, the aggregated energy data including energy data generated by the plurality of energy interconnection subsystems and transmitted, over the communication network, to the data center. For example, the aggregated energy data may be generated by the data center (e.g., processing circuitry thereof) using the energy data, with the energy data in turn being generated using a sensor (e.g., of a bus) in each energy interconnection subsystem, such as described above.

In some embodiments, the processing circuitry of each energy interconnection subsystem may be further configured to, based on the aggregated energy data, operate the plurality of switches to connect and/or disconnect the energy source connection interface to and/or from the energy draw connection interface. For example, where the aggregated energy data indicates greater than a threshold amount of aggregate energy usage, the processing circuitry may be configured to operate the switches to disconnect a power grid connection interface from an energy draw connection interface (e.g., EV charging connection interface). For instance, the energy draw connection interface may (e.g. instead) be connected to an ESS connection interface and/or a solar power connection interface. Similarly, as an example, where the aggregated energy data indicates less than a threshold amount of aggregate energy usage, the processing circuitry may be configured to operate the switches to connect a power grid connection interface to an energy draw connection interface (e.g., EV charging connection interface and/or ESS connection interface). As yet another example, where the aggregated energy data indicates greater than a threshold amount of aggregate energy usage, the processing circuitry may be configured to operate the switches to connect an energy source connection interface (e.g., ESS connection interface and/or solar power connection interface) to a power grid connection interface, such as to transmit power to the power grid connection interface.

In some embodiments, the processing circuitry of an energy interconnection subsystem may be configured to execute a trained model, input the aggregated energy data to the trained model, and operate the switches based on a resulting output of the trained model, such as described above. For example, the trained model may include a trained statistical classifier, and the resulting output may include an indication of a predicted need for additional energy (e.g., at other energy interconnection subsystems in the distributed systems) and/or an indication of a predicted surplus of additional energy (e.g., for sourcing via a power grid connection interface).

In some embodiments, the data center may include processing circuitry configured to receive the energy data from each of the plurality of energy interconnection subsystems over the communication network, aggregate the energy data into the aggregated energy data, and transmit the aggregated energy data to each of the plurality of energy interconnection subsystems over the communication network, such as described above.

According to an aspect of the present disclosure, a distributed system may include a plurality of energy interconnection subsystems and a data center, such as described above. For example, each energy interconnection subsystem may include energy connection interfaces including an energy source connection interface and an energy draw connection interface, a bus coupled to and between each of the plurality of energy connection interfaces and comprising a sensor, a plurality of switches each coupled to and between the bus and a respective energy connection interface of the plurality of energy connection interfaces and processing circuitry coupled to the bus and to each of the plurality of switches. In some embodiments, the data center may include processing circuitry in communication with the processing circuitry of each of the plurality of energy interconnection subsystems over a communication network, such as described above.

In some embodiments, the processing circuitry of the data center may be configured to obtain from the processing circuitry of the plurality of energy interconnection subsystems, over the communication network, energy data from the buses based on sensor data generated by the sensors at least during transmission of energy between the energy source connection interfaces and the energy draw connection interfaces, respectively, such as described above.

In some embodiments, the processing circuitry of the data center may be configured to aggregate the energy data into aggregated energy data and, based on the aggregated energy data, associate the energy source connection interface of a first energy interconnection subsystem of the energy interconnection subsystems with the energy draw connection interface of a second energy interconnection subsystem of the energy interconnection subsystems. For example, associating an energy source connection interface of a first energy interconnection subsystem with an energy draw connection interface of a second energy interconnection subsystem may associate energy drawn from the energy source connection interface with energy supplied to the energy draw connection interface. For instance, the energy draw connection interface and the energy source connection interface may each include a power grid connection interface, and the association may include energy being effectively transferred between the first energy interconnection subsystem and the second energy interconnection subsystem. In some embodiments, energy may be effectively transferred between energy interconnection subsystems, even if energy is not actually transferred therebetween, if the energy is matched (e.g., for consumption and cost purposes).

In some embodiments, the processing circuitry of the data center may be configured to associate the energy source connection interface of the first energy interconnection subsystem with the energy draw connection interface of the second energy interconnection subsystem at least in part by transmitting an indication to the first energy interconnection subsystem, over the communication network, for the processing circuitry of the first energy interconnection subsystem to operate the switches thereof to connect the bus to the energy source connection interface, and transmitting an indication to the second energy interconnection subsystem, over the communication network, for the second energy interconnection subsystem to operate the plurality of switches to connect the bus to the energy draw connection interface. For example, the association may include an association of switching actions at the respective energy interconnection subsystems that reflect an effective transfer of energy therebetween.

In some embodiments, processing circuitry of the data center may be configured to associate the energy source connection interface of the first energy interconnection subsystem with the energy draw connection interface of the second energy interconnection subsystem responsive to determining that a condition is satisfied. For example, a condition may include compatibility between a prediction of energy available from an energy source connection interface of a first energy interconnection subsystem and a prediction of energy needed at an energy draw connection interface of a second energy interconnection subsystem. For instance, predicted amounts of energy available and needed may match (e.g., by being within a threshold amount of one another) sufficiently for association between the energy source connection interface and the energy draw connection interface.

In some embodiments, determining that a condition is satisfied may be based on the aggregated energy data, the energy data from the first energy interconnection subsystem, and the energy data from the second energy interconnection subsystem. For example, the aggregated energy data may indicate an aggregate availability and usage of energy, the energy data from the first energy interconnection subsystem indicates a prediction of energy available from the energy source connection interface and the energy data from the second energy interconnection subsystem indicates a prediction of energy needed at the energy draw connection interface.

According to an aspect of the present disclosure, a method of operating an energy interconnection subsystem may include receiving, by processing circuitry of an energy interconnection subsystem, aggregated energy data over a communication network, the aggregated energy data being representative of energy data obtained from a plurality of energy interconnection subsystems connected to a data center over the communication network, such as described above. In some embodiments, the method may further include operating in a first mode, including inputting the aggregated energy data to a first model, and, based on an output from the first model, controlling switches interconnecting a plurality of energy interconnection interfaces. For example, the first mode may be an energy efficiency mode and the first model may be configured to prioritize (e.g., in an optimization algorithm and/or via training) interconnection that sources energy locally and/or via a power grid connection interface based on efficiency. In some embodiments, the method may further include operating in a second mode, including inputting the aggregated energy data to a second model, and, based on an output from the second model, controlling the switches. For example, the second mode may be a performance mode and the second model may be configured to prioritize (e.g., in an optimization algorithm and/or via training) interconnection that provides a steady and/or sufficient power supply to support an energy draw connection interface (e.g., EV charging connection interface) when such power is needed.

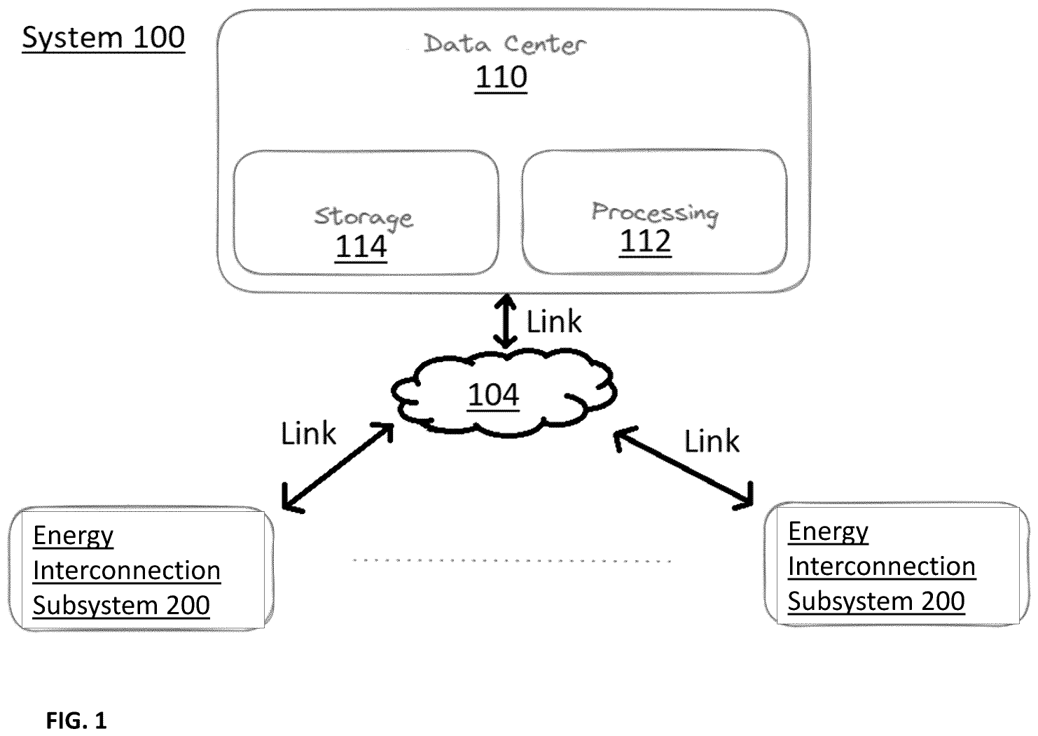

FIG. 1 is a block diagram of an example distributed system 100, according to some embodiments. As shown in FIG. 1, distributed system 100 includes a data center 110 and energy interconnection subsystems 200. As shown in FIG. 1, data center 110 includes processing circuitry 112 and storage 114, which may be configured as volatile and/or non-volatile memory.

In some embodiments, each of energy interconnection subsystems 200 may be located at a different geographical location. For example, each energy interconnection subsystem 200 may be located at a different property, such as a house or other building or group of buildings within a given arca.

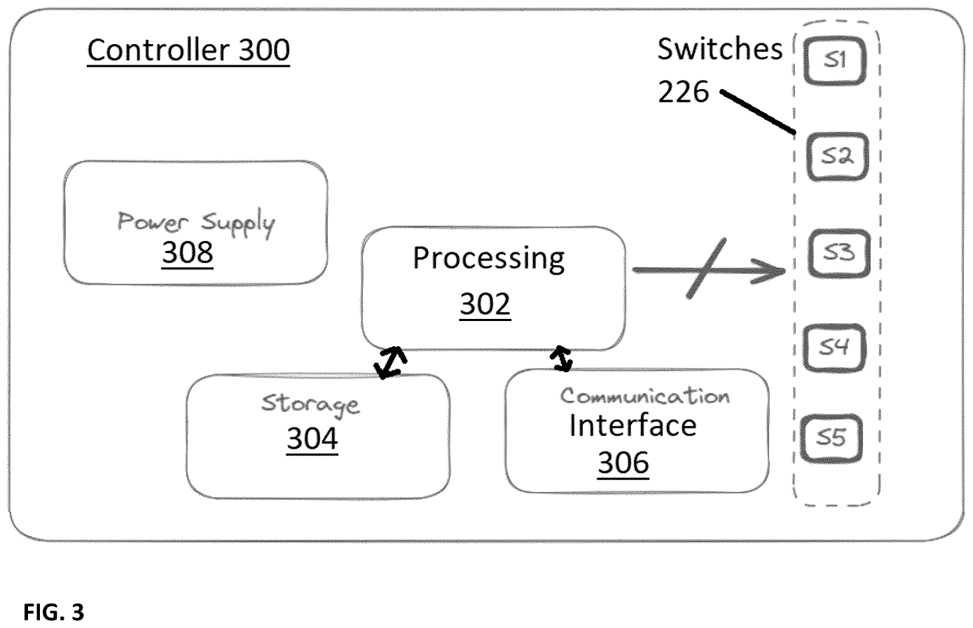

In some embodiments, data center 110 and energy interconnection subsystems 200 may be communicatively coupled via a communication network. In the illustrated embodiment, data center 110 and energy interconnection subsystems are interconnected via a communication network 104. For example, communication network 104 may be the Internet, and/or may be a private network whether wired or wireless. In some embodiments, connectivity may be achieved via communication interfaces executed by processing circuitry 112 of data center 110 and processing circuitry (FIG. 3) of energy interconnection subsystems 200.

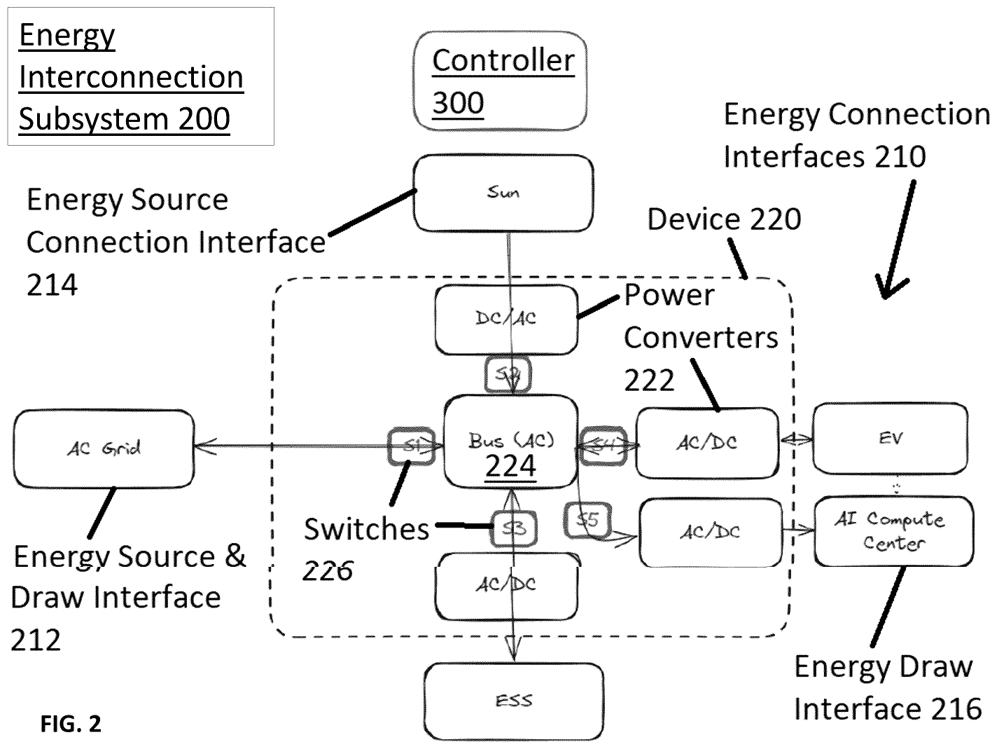

FIG. 2 is a block diagram of an example energy interconnection subsystem 200 of system 100, according to some embodiments. In the illustrated embodiment, energy interconnection subsystem 200 includes a device 220, energy connection interfaces 210 which may be controllably connected to device 220, and a controller 300 that may be configured to control connections between device 220 and energy connection interfaces 210.

As shown in FIG. 2, energy interconnection interfaces 210 include an energy source connection interface 214 and an energy draw connection interface 216. In the illustrated embodiment, energy source connection interface 214 is shown for example as a solar power connection interface, and energy draw connection interface 216 is shown for example as a dedicated power supply line for a local machine learning computation center. In some embodiments, energy source connection interfaces may be further configured as energy draw connection interfaces and vice versa. For example, in FIG. 1, an energy source and draw connection interface 212 is shown for example as a power grid connection interface. Other examples of energy source and draw connection interfaces may include an ESS connection interface, and even an electric vehicle charging interface (in some instances). For instance, an energy source interconnection interface that is only operable unidirectionally (e.g., a solar power connection) may not be configured also as an energy draw connection interface and vice versa, whereas an energy source connection interface or energy draw connection interface that may be operated bidirectionally (e.g., a power grid or ESS connection) may be configured as an energy source at some times and to draw energy from another source at other times. Thus, in some cases, an energy source connection interface may be an energy source and draw connection interface, as may be an energy draw connection interface.

Also shown in FIG. 2, device 220 of energy interconnection subsystem 200 includes a bus 224 coupled to and between each of energy connection interfaces 210. In some embodiments, power converters 222 may be coupled between at least some energy connection interfaces 210 and bus 224. For example, in FIG. 2, bus 224 is shown configured as an alternating current (AC) bus that may be connected to energy source and draw interface 212, shown as an AC power grid connection, without a power converter, whereas a power converter 222 is shown coupled between bus 224 and energy source connection interface 214, shown as a solar power connection interface, to convert between DC at the solar power connection interface and AC within bus 224.

Also shown in FIG. 2, device 220 of energy interconnection subsystem 200 further includes switches 226, each coupled to and between bus 224 and a respective energy connection interface of energy connection interfaces 210. For example, in the illustrated embodiment, switch S1 is coupled to and between bus 224 and energy source and draw connection interface 212, switch S2 is coupled to and between bus 224 and energy source connection interface 214, switch S3 is coupled to and between bus 224 and an ESS connection interface, switch S4 is coupled to and between bus 224 and an electric vehicle (EV) connection interface, and switch S5 is coupled to and between bus 224 and energy draw connection interface 216.

In some embodiments, bus 224 may include a sensor. For example, bus 224 may be configured to provide an electrical path for energy to flow between energy interconnection interfaces 210, which may facilitate using the sensor to detect characteristics of energy flowing in the electrical path. For instance, the sensor may be configured to detect voltage and/or current of energy flowing in the electrical path as an indication of power being transferred between particular energy interconnection interfaces 210. Some embodiments may alternatively or additionally sense a local temperature, which may be useful for safety monitoring.

FIG. 3 is a block diagram of an example controller 300 coupled to switches 226 of device 220 of energy interconnection subsystem 200, according to some embodiments.

As shown in FIG. 3, controller 300 includes processing circuitry 302, storage 304, communication interface 306 and power supply 308. In the illustrated embodiment, processing circuitry 302 is coupled to each of switches 226. In some embodiments, processing circuitry 302 may be in communication with communication network 104 (FIG. 1), such as via communication interface 306 in FIG. 3. For instance, processing circuitry 302 may be in communication with data center 110 (FIG. 1) over communication network 104.

In some embodiments, processing circuitry 302 may be further coupled to bus 224, such as to receive energy data from bus 224 based on sensor data generated by the sensor at least during transmission of energy between energy interconnection interfaces 210. For example, transmission of power between energy interconnection interfaces 210 may generate sensor data such as a voltage and/or current measurement, which may indicate energy usage in energy interconnection subsystem 200. In some embodiments, processing circuitry 302 may be configured to transmit the energy data to data center 110 (FIG. 1) over communication network 104 (FIG. 1). In some embodiments, processing circuitry 302 may include digital signal processing (DSP) circuitry configured to receive and transmit energy data (e.g., from bus 224). For example, using DSP circuitry to receive and transmit energy data may provide advantageously low communication latency, which may be useful in some applications, such as in some cases where energy data is to be generated and/or streamed in real-time for real-time control of energy interconnections based thereon.

Returning briefly to FIG. 1, in some embodiments, processing circuitry 112 of data center 110 may be configured to receive and aggregate energy data from each of the plurality of energy interconnection subsystems 200 into aggregated energy data. For example, the energy data may be based on sensor data generated by bus 224 (FIG. 2) and transmitted to data center 110 over communication network 104. For instance, at each energy interconnection subsystem 200, such sensor data that may be useful on its own for analyzing localized energy interconnection may be aggregated at data center 110 for use in large scale analysis of energy interconnection. In some embodiments, processing circuitry 112 may be further configured to transmit the aggregated energy data to each of the plurality of energy interconnection subsystems 200.

In some embodiments, processing circuitry 302 (FIG. 3) may be configured to operate switches 226 based on aggregated energy data received via communication interface 306, such as from data center 110. For example, processing circuitry 302 may be configured to operate switches 226 to connect and/or disconnect energy connection interfaces 210 to and/or from one another. In some embodiments, aggregated energy data based on energy data from a plurality of energy interconnection subsystems may be useful to inform an interconnect action to be taken at a given energy interconnection subsystem by local processing circuitry 302. For example, processing circuitry 302 may be configured to close switches S1 and S2 of switches 226 to connect energy source connection interface 214 to energy source and draw interface 212, such as to provide solar energy to the power grid, which may be based on determining that there is a current or imminent high demand for energy via the power grid. Alternatively or additionally, processing circuitry 302 may be configured to close switches S2 and S3 of switches 226 to connect energy source connection interface 214 to an ESS, such as to store solar energy in local energy storage, which may be based on determining that there is expected to be a high demand for energy in the near future.

In some embodiments, DSP of processing circuitry 302 may be configured to control operation of switches 226. For example, switches 226 may include digitally-controlled switches. In some embodiments, switches 226 may include digitally-controlled power relays, such as G9KA power relays from OMRON Corp. For example, using DSP in combination with digitally-controlled relays may provide advantageously low switching latency in a high power environment, which may be useful in some applications, such as in some cases where real-time switch control may be based on real-time energy data.

In some embodiments, aggregated energy data received via communication interface 306 may indicate greater than a threshold amount of aggregate energy usage (e.g., among energy interconnection subsystems 200 in communication with data center 110), and processing circuitry 302 may be configured to, based on the aggregated energy data, operate switch S1 (e.g., and/or S5) to disconnect a power grid connection interface (e.g., source and draw connection interface 212) from an energy draw connection interface (e.g., 216). For example, processing circuitry 302 may be configured to determine, based on a high aggregate energy usage, that interconnection of a power grid connection interface to an energy draw connection interface at that time is inefficient (e.g., compared to sourcing energy from an ESS). In some embodiments, processing circuitry 302 may be configured to, based on the aggregated energy data indicating greater than a threshold amount of aggregate energy usage, operate switch S1 (e.g., and/or S3) to connect a power grid connection interface to an energy source connection interface (e.g., of an ESS). For example, processing circuitry 302 may be configured to determine, based on a high aggregate energy usage, that interconnection of a power grid connection interface to an energy source connection interface at that time is efficient (e.g., to provide stored energy from the energy interconnection subsystem 200 during a time of high usage).

In some embodiments, aggregated energy data received via communication interface 306 may indicate less than a threshold amount of aggregate energy usage, and processing circuitry 302 may be configured to operate switch S1 (e.g., and/or S5) to connect a power grid connection interface to an energy draw connection interface (e.g., 216). For example, processing circuitry 302 may be configured to determine, based on a low aggregate energy usage, that interconnection of a power grid connection interface to an energy draw connection interface at that time is efficient (e.g., compared to sourcing energy from an ESS). For instance, processing circuitry 302 may be configured to monitor aggregated energy data (e.g., in a stream from data center 110) and determine, based on whether aggregate energy usage is above or below a threshold, and responsively connect or disconnect the power grid connection interface to or from the energy draw connection interface.

In some embodiments, processing circuitry 112 of data center 110 (FIG. 1) may be alternatively or additionally configured to associate energy connection interfaces 210 of multiple energy interconnection subsystems 200 with one another based on aggregated energy data. For example, processing circuitry 112 of data center 110 may be configured to associate an energy draw connection interface 212 of a first energy interconnection subsystem 200 with an energy source connection interface 214 of a second energy interconnection subsystem 200, such as to associate energy drawn from the energy source connection interface 214 with energy supplied to the energy draw connection interface 212. For instance, the energy draw connection interface and the energy source connection interface may each be a power grid connection interface, and the association may include energy being effectively transferred between the first energy interconnection subsystem 200 and the second energy interconnection subsystem 200. As described herein, energy may be effectively transferred between energy interconnection subsystems 200, even if energy is not actually transferred therebetween, if the energy is matched (e.g., for consumption and cost purposes).

In some embodiments, processing circuitry 302 may be configured to execute a model, input aggregated energy data from data center 110 to the model, and operate switches 226 based on a resulting output of the model. For example, the model output may include an indication of a predicted need for additional energy (e.g., to be sourced by operating switches 226) and/or an indication of a predicted surplus of energy (e.g., to be drawn by operating switches 226). For instance, a model output may be based on statistical analysis of and/or training on aggregated energy data to support a prediction. In some embodiments, a model as described herein may be and/or include a trained model. For example, a trained model, such as a trained statistical classifier, may be trained on aggregated energy data and labeled outputs indicating high current aggregate energy usage, low current aggregate energy usage, and/or current usage data associated with (e.g., known to predicate) a predicted need for additional energy and/or a predicted surplus of energy. For instance, operating switches 226 of an energy interconnection subsystem 200 may be based, at least in part, on local execution of a trained model at the energy interconnection subsystem 200 having aggregated energy data as an input, to increase efficiency of energy interconnections (e.g., and associated sourcing and/or draw) at the energy interconnection subsystem.

In some embodiments, operation of switches 226 may be at least partially based on aggregated energy data stored (e.g., over time) at the energy interconnection subsystem 200. For example, alternatively or in addition to aggregated energy data received (e.g., in real time) from data center 110, in some embodiments, processing circuitry 302 may be configured to provide stored aggregated energy data (e.g., indicating usage and/or availability of energy over time) to a model, alone or in combination with other aggregated energy data (e.g., received in real time from data center 110). For example, processing circuitry 302 may be configured to operate switches 226 at least in part based on real-time aggregated energy data in context of a larger time period of aggregated energy data and/or context of current, local energy data (e.g., ESS storage level status, current computational load in a machine learning compute center, current solar energy input, current vehicle charge level status, etc.).

In some embodiments, processing circuitry 112 of data center 110 (FIG. 1) may be configured to associate energy connection interfaces 210 (FIG. 2) of multiple energy interconnection subsystems 200 at least in part by transmitting indications to the energy interconnection subsystems 200, over communication network 104, to interconnect the energy connection interfaces 210. For example, an indication transmitted to the first energy interconnection subsystem 200 over communication network 104 may be for processing circuitry 302 (FIG. 3) of the first energy interconnection subsystem 200 to operate switches 226 to connect bus 224 (FIG. 2) to an energy source connection interface 214, and an indication transmitted to the second energy interconnection subsystem 200 over communication network 104 may be for processing circuitry 302 of the second energy interconnection subsystem 200 to operate switches 226 to connect bus 224 to an energy draw connection interface 212. For instance, in the first energy interconnection subsystem 200, switches S1 and S2 (and/or S3) may be closed, such as to provide energy (e.g., from solar or energy storage) to the power grid. Similarly, in the second energy interconnection subsystem 200, switches S1 and S4 (and/or S5) may be closed, such as to draw energy (e.g., for EV charging and/or an ML compute center) from the power grid.

In some embodiments, processing circuitry 112 of data center 110 (FIG. 1) may be configured to associate energy connection interfaces 210 of multiple energy interconnection subsystems 200 (FIG. 2) with one another responsive to determining that a condition is satisfied. For example, processing circuitry 112 may be configured to determine whether the condition is satisfied based on one or more of the aggregated energy data, energy data from a first energy interconnection subsystem 200, and/or energy data from a second energy interconnection subsystem 200 (e.g., where the first and second energy interconnection subsystems 200 are to be associated based on the condition).

In some embodiments, aggregated energy data generated by data center 110 may indicate an aggregate availability and/or usage of energy. For example, the aggregated energy data may indicate a total availability (e.g., based on supply data from one or more energy supply) and/or may indicate a total usage (e.g., based on energy data from some or all energy interconnection subsystems, alone or in combination with supply data). In some embodiments, energy data from a first energy interconnection subsystem 200 may indicate a prediction of energy available from an energy source connection interface. For example, the energy data may indicate storage of energy in an ESS and/or current (and/or predicted) generation of energy using solar power. In some embodiments, energy data from a second energy interconnection subsystem 200 may indicate a prediction of energy needed at an energy draw connection interface. For example, the energy data may indicate drawing of energy (e.g., from a power grid connection interface and/or other source connection interfaces local to the subsystem). In some embodiments, actual energy available and/or being drawn may be determined from the energy data, and/or in some embodiments actual energy generated and/or being drawn may form at least a partial basis for predicting availability and/or energy draw (e.g., based on past energy generation and/or draw data).

In some embodiments, a condition whose satisfaction predicates association of energy connection interfaces 210 of multiple energy interconnection subsystems 200 may include compatibility between a prediction of energy available from an energy source connection interface of a first energy interconnection subsystem 200 and a prediction of energy needed at an energy draw connection interface of a second energy interconnection subsystem 200. For example, predicted amounts of energy available and needed may match (e.g., by being within a threshold amount of one another) sufficiently for association between the energy source connection interface and the energy draw connection interface. In some embodiments, an alternative or additional condition usable in such a system is a cost of the energy matched between the associated connection interfaces of the respective subsystems, which may be calculated at least in part based on energy available in the distributed system and/or on a larger scale.

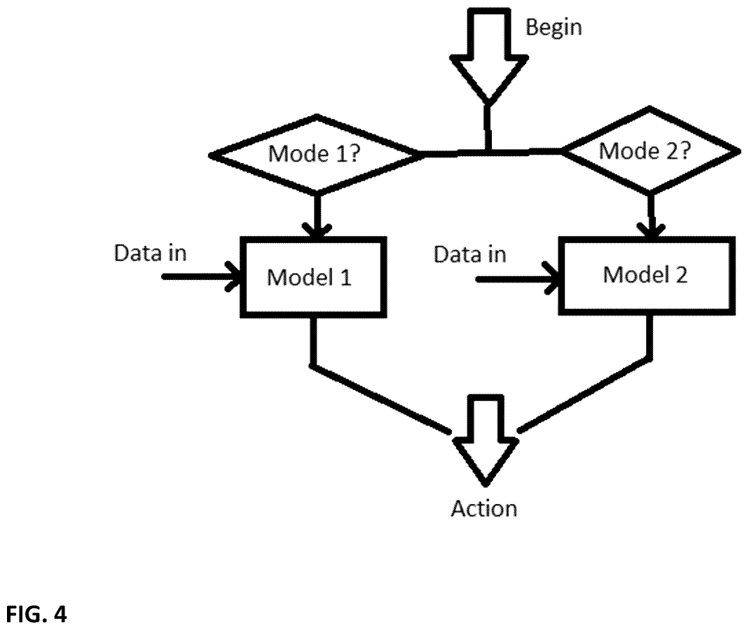

FIG. 4 is a flow diagram of an example method of controlling energy interconnection in an energy interconnection subsystem 200 using multiple modes of operation, according to some embodiments.

In some embodiments, operation of an energy interconnection subsystem 200 may include multiple operating modes. For example, a first mode of operation may efficiently draw less energy than a second mode of operation (e.g., a performance mode). For instance, a mode of operation may be preset within the energy interconnection subsystem 200, and/or may be controlled by a user, and/or may be determined based on an amount of aggregate energy usage indicated by aggregated energy data received at the energy interconnection subsystem 200, according to various embodiments.

In some embodiments, operation of an energy interconnection subsystem 200 may include receiving (e.g., by processing circuitry 302 in FIG. 3) aggregated energy data over a communication network (e.g., 104 in FIG. 1). For example, as described above, the aggregated energy data may be representative of energy data obtained from a plurality of energy interconnection subsystems 200 connected to data center 110 over communication network 104. For instance, the aggregated energy data may indicate aggregate energy usage (e.g., in real-time).

In some embodiments, at least some processing of the aggregated energy data may depend on a mode of operation of energy interconnection subsystem 200, such as shown in FIG. 4. For example, the illustrated flow diagram branches between a first mode (Mode 1) and a second mode (Mode 2), which may be determined as described above. In the illustrated embodiment, the first mode leads to execution of a first model (Model 1) and the second mode leads to execution of a second model (Model 2), with results of the models leading to an action. For example, the action may include controlling switches 226 based on an output from the respective model. In some embodiments, the models may include trained models, and/or statistical analysis and/or optimization models, depending on the embodiment. For instance, the trained models may be trained as described above (e.g., for high energy draw and/or to predict different interconnections depending on sourcing and/or drawing power during high and/or low consumption times using real-time data).

In some embodiments, operating in the first mode may include inputting the received aggregated energy data to the first model. For example, the first model may be configured to output a suggested action, such as a configuration of switches 226, based on the aggregated energy data. For instance, where the aggregated energy data indicates a current or predicted high availability of energy, the suggested action may include connecting an energy draw connection interface to a power grid connection interface (e.g., to draw power from the power grid, such as to an ESS), whereas when the aggregated energy data indicates a current or predicted low availability of energy, the suggested action may include connecting an energy source connection interface to a power grid connection interface (e.g., to supply power to the power grid, such as from an ESS). In some embodiments, operating in the first mode may result in little energy draw and/or high energy sourcing during times determined to have high energy usage and/or low energy availability, and/or substantially all energy draw during times determined to have low energy usage and/or high energy availability, which may result in efficient operation.

In some embodiments, operating in the second mode may include inputting the received aggregated energy data to a second model. For example, the second model may be configured to output a suggested action, such as a configuration of switches 226, based on the aggregated energy data, such as described for the first model. In contrast to the first model, for instance, the second model may tend to suggest an action of connecting an energy draw connection interface to a power grid connection interface (e.g., to draw power from the power grid, such as to an EV and/or machine learning compute center), though in some cases the amount and/or percentage of energy drawn from the power grid connection interface (e.g., compared to energy drawn from an ESS) may depend on the aggregated energy data. In some embodiments, operating in the second mode may result in high energy draw, which may be useful at a given time, such as to perform fast charging of an EV and/or machine learning computations that require substantial energy draw. In some embodiments, operation in different modes at different times may advantageously provide and/or balance efficient energy interconnection and high performance of interconnected systems.

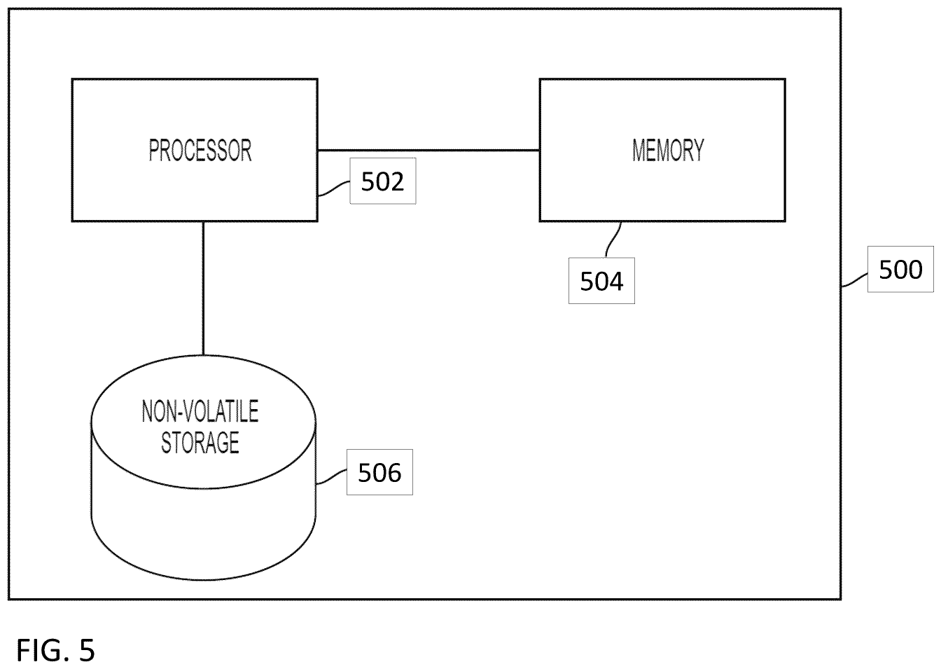

FIG. 5 is a block diagram of example processing circuitry 500 that may be configured to perform at least some processing operations described herein for system 100, in accordance with some embodiments.

In some embodiments, processing circuitry 112 and/or processing circuitry 302 may be configured as described herein for processing circuitry 500 (e.g., implemented using components mounted on and/or coupled to a substrate of a device). Processing circuitry 500 may include one or more processors 502 and one or more articles of manufacture that comprise non-transitory computer-readable storage media (e.g., memory 504 and one or more non-volatile storage media 506). The processor 502 may control writing data to and reading data from the memory 504 and the non-volatile storage device 506 in any suitable manner, as the aspects of the disclosure provided herein are not limited in this respect. To perform any of the functionality described herein, the processor 502 may execute one or more processor-executable instructions stored in one or more non-transitory computer-readable storage media (e.g., the memory 504), which may serve as non-transitory computer-readable storage media storing processor-executable instructions for execution by the processor 502.

While several embodiments of the present technology have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present application.

The above-described embodiments may be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media may be transportable, such that the program or programs stored thereon may be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present disclosure need not reside on a single computer or processor, but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code may be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more input and output devices. These devices may be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the technology described herein. It is, therefore, to be understood that the foregoing embodiments are presented by way of example only and that, within the scope of the appended claims and equivalents thereto, the aspects of the technology may be practiced otherwise than as specifically described and claimed. The present application is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present application. All definitions, as defined and used herein, should be understood to control over dictionary definitions, definitions in documents incorporated by reference, and/or ordinary meanings of the defined terms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A distributed system, comprising:
a data center; and
a plurality of energy interconnection subsystems, each comprising:
a plurality of energy connection interfaces comprising an energy source connection interface and an energy draw connection interface;
a bus coupled to and between each of the plurality of energy connection interfaces and comprising a sensor;
a plurality of switches each coupled to and between the bus and a respective energy connection interface of the plurality of energy connection interfaces; and
processing circuitry coupled to the bus and to each of the plurality of switches and in communication with the data center over a communication network, the processing circuitry configured to:
receive energy data from the bus based on sensor data generated by the sensor at least during transmission of energy between the energy source connection interface and the energy draw connection interface; and
transmit the energy data to the data center over the communication network.

2. The distributed system of claim 1, wherein each of the plurality of energy interconnection subsystems is located at a different geographical location.

3. The distributed system of claim 1, wherein the processing circuitry comprises digital signal processing circuitry configured to receive and transmit the energy data and further to control operation of the plurality of switches.

4. The distributed system of claim 1, wherein the plurality of switches comprises a plurality of digitally controlled power relays.

5. The distributed system of claim 1, wherein the data center comprises processing circuitry configured to:
receive and aggregate the energy data from each of the plurality of energy interconnection subsystems into aggregated energy data; and
transmit the aggregated energy data to each of the plurality of energy interconnection subsystems.

6. The distributed system of claim 5, wherein the processing circuitry of a first energy interconnection subsystem of the plurality of energy interconnection subsystems is configured to receive the aggregated energy data and control the plurality of switches of the first energy interconnection subsystem based on the aggregated energy data.

7. The distributed system of claim 6, wherein the processing circuitry of the first energy interconnection subsystem is configured to input the aggregated energy data to a trained model and control the plurality of switches based on a resulting output of the trained model.

8. A distributed system, comprising:
a data center; and
a plurality of energy interconnection subsystems, each comprising:
a plurality of energy connection interfaces comprising an energy source connection interface and an energy draw connection interface;
a plurality of switches each coupled to and between the plurality of energy connection interfaces; and
processing circuitry coupled to each of the plurality of switches and in communication with the data center over a communication network, the processing circuitry configured to:
receive aggregated energy data from the data center over the communication network, the aggregated energy data including energy data generated by the plurality of energy interconnection subsystems and transmitted, over the communication network, to the data center; and
based on the aggregated energy data, operate the plurality of switches to connect and/or disconnect the energy source connection interface to and/or from the energy draw connection interface.

9. The distributed system of claim 8, wherein the processing circuitry is configured to execute a trained model, input the aggregated energy data to the trained model, and operate the plurality of switches based on a resulting output of the trained model.

10. The distributed system of claim 9, wherein the trained model comprises a trained statistical classifier, and the resulting output comprises:
an indication of a predicted need for additional energy; and/or
an indication of a predicted surplus of additional energy.

11. The distributed system of claim 8, wherein:
the aggregated energy data indicates greater than a threshold amount of aggregate energy usage;
the energy source connection interface comprises a power grid connection interface; and
the processing circuitry is configured to operate the plurality of switches to disconnect the power grid connection interface from the energy draw connection interface.

12. The distributed system of claim 8, wherein:
the aggregated energy data indicates less than a threshold amount of aggregate energy usage;
the energy source connection interface comprises a power grid connection interface; and
the processing circuitry is configured to operate the plurality of switches to connect the power grid connection interface to the energy draw connection interface.

13. The distributed system of claim 11, wherein the energy draw connection interface comprises a vehicle charging connection interface and/or an energy storage system connection interface.

14. The distributed system of claim 8, wherein:
the aggregated energy data indicates greater than a threshold amount of aggregate energy usage;
the energy draw connection interface comprises a power grid connection interface; and
the processing circuitry is configured to operate the plurality of switches to connect the energy source connection interface to the power grid connection interface.

15. The distributed system of claim 14, wherein the energy source connection interface comprises a solar power connection interface and/or an energy storage system connection interface.

16. The distributed system of claim 8, wherein each of the plurality of energy interconnection subsystems further comprises:
a bus coupled to and between each of the plurality of energy connection interfaces and comprising a sensor, with the plurality of switches coupled to and between the bus and a respective energy connection interface of the plurality of energy connection interfaces.

17. The distributed system of claim 16, wherein the energy data is generated by the sensors of the plurality of energy interconnection subsystems and transmitted by the processing circuitry of the plurality of energy interconnection subsystems, over the communication network, to the data center.

18. The distributed system of claim 8, wherein each of the plurality of energy interconnection subsystems is located at a different geographical location.

19. The distributed system of 8, wherein the data center comprises processing circuitry configured to:
receive the energy data from each of the plurality of energy interconnection subsystems over the communication network;
aggregate the energy data into the aggregated energy data; and
transmit the aggregated energy data to each of the plurality of energy interconnection subsystems over the communication network.

20. A distributed system, comprising:
a plurality of energy interconnection subsystems, each comprising:
a plurality of energy connection interfaces comprising an energy source connection interface and an energy draw connection interface;
a bus coupled to and between each of the plurality of energy connection interfaces and comprising a sensor;
a plurality of switches each coupled to and between the bus and a respective energy connection interface of the plurality of energy connection interfaces; and
processing circuitry coupled to the bus and to each of the plurality of switches; and
a data center comprising processing circuitry in communication with the processing circuitry of each of the plurality of energy interconnection subsystems over a communication network, wherein the processing circuitry of the data center is configured to:
obtain from the processing circuitry of the plurality of energy interconnection subsystems, over the communication network, energy data from the buses based on sensor data generated by the sensors at least during transmission of energy between the energy source connection interfaces and the energy draw connection interfaces, respectively;
aggregate the energy data into aggregated energy data; and
based on the aggregated energy data, associate the energy source connection interface of a first energy interconnection subsystem of the plurality of energy interconnection subsystems with the energy draw connection interface of a second energy interconnection subsystem of the plurality of energy interconnection subsystems.

21-27. (Canceled)
